(19) United States
(12) Patent Application Publication
(10) Pub. No.: US 2021/0024398 A1
(43) Pub. Date: Jan. 28, 2021

(54) GLASS FIBER TANK KILN PASSAGE CROWN STRUCTURE

(71) Applicant: JUSHI GROUP CO., LTD., Tongxiang (CN)

(72) Inventors: Changying FANG, Tongxiang (CN); Lifeng YU, Tongxiang (CN); Yucang YAN, Tongxiang (CN); Xianliang ZHAO, Tongxiang (CN); Peijun SHEN, Tongxiang (CN); Xiaodong WENG, Tongxiang (CN)

(21) Appl. No.: 17/044,593

(22) PCT Filed: Mar. 21, 2019
(86) PCT No.: PCT/CN2019/079068

§ 371 Date: Oct. 1, 2020

(30) Foreign Application Priority Data
Jun. 21, 2018 (CN) 201810641728.0

(51) Int. Cl. C03B 5/43

(52) U.S. Cl. CPC C03B 5/43

(57) ABSTRACT

A glass fiber tank kiln passage crown structure includes a chest wall brick, a supporting column built on a top of the chest wall brick, and a crown having an arch structure. Two ends of the crown are built on the supporting column, and a span of the crown is in a range from 0.5 meters to 4 meters.

The present application claims priority to Chinese Patent Application No. 201810641728.0, filed to the National Intellectual Property Administration, PRC on Jun. 21, 2018 and entitled “Glass Fiber Tank Kiln Passage Crown Structure,” the disclosure of which is incorporated herein by reference in its entirety.

### TECHNICAL FIELD

The present disclosure relates to the field of glass fiber production technology, and in particular to a glass fiber tank kiln passage crown structure.

### BACKGROUND

In the existing technologies, the roof of a glass fiber tank kiln passage is a cover plate structure, as shown in FIG. 1. Situated at the top of the passage flame space, the roof is generally composed of a cover brick 101, a chest wall brick 102 and an insulation brick 103. The cover brick 101, being vertical to the chest wall brick 102, is directly built on the chest wall brick 102. The insulation brick 103 is coated on the surfaces of the cover brick 101 and the chest wall brick 102. During the operation of the tank kiln, the gas burns in the flame space of the passage, and the generated high-temperature combustion gas is discharged through the chimney at the end of the passage. For a passage structure of this type, the width of the passage should not be more than 1 meter. If the passage becomes too wide, both the width and the weight of the cover brick 101 will increase, which will cause great difficulties for the construction of the passage. Moreover, after the kiln operates for a certain period of time, the cover brick may soften and sink under a combined influence of high temperature and its own weight, and the refractory scraps caused by such softening and sinking may fall into the molten glass thereunder, thus affecting the glass quality.

On the other hand, with the improvement of production processes and higher requirements for production and technology, the tank kiln as a whole becomes larger and larger, which requires the design of the passage having a width of more than 1 meter. In that case, the conventional cover plate for the passage will no longer be applicable, as it is difficult to be installed, and there will also be significant safety risks during the operation of the passage.

The melting zone of an existing kiln adopts a crown structure. The span of the melting zone is large, usually more than 5 meters, the temperature inside the chamber is greater than 1,550° C., and the crown is generally equipped with burners. So for the safety of the crown, the crown height is normally set to be greater than 500 mm. But as the temperature of the passage is relatively low, usually between 1,400° C. and 1,500° C., the crown structure of the passage tends to be quite different from that of the melting zone.

### SUMMARY OF THE PRESENT DISCLOSURE

The present disclosure aims to solve the issue described above. The purpose of the disclosure is to provide a glass fiber tank kiln passage crown structure to solve the above technical problems. The passage crown structure comprises a chest wall brick, a supporting column and a crown. The crown is of an arch structure. The supporting column is built on the top of the chest wall brick, and the two ends of the crown are built on the supporting column.

Wherein, the span L of the crown is 0.5 to 4.0 meters, preferably 0.8 to 3.0 meters, more preferably 1.0 to 2.0 meters, and even more preferably 1.0 to 1.5 meters.

Wherein, the central angle α of the crown is 20° to 70°, preferably 30° to 60°, and more preferably 40° to 50°.

Wherein, the ratio of the height H to the span L of the crown is 0.044 to 0.158, preferably 0.066 to 0.134, and more preferably 0.088 to 0.111.

Wherein, the span L of the crown is 0.5 to 4.0 meters, and correspondingly, the central angle α of the crown is 20° to 70° and the ratio of the height H to the span L of the crown is 0.044 to 0.158. Preferably, the span L of the crown is 1.0 to 2.0 meters, and correspondingly, the central angle α of the crown is 40° to 50° and the ratio of the height H to the span L of the crown is 0.088 to 0.111.

Wherein, the crown comprises a crown brick layer and an insulation layer, with the insulation layer covering and being built on the upper surface of the crown brick layer.

Wherein, the crown brick layer comprises a plurality of crown bricks built side by side, and the crown brick is in the shape of an arch. The insulation layer comprises a plurality of insulation bricks laid in sequence, and the laying direction of the insulation bricks is perpendicular to that of the crown bricks.

Wherein, the crown brick layer comprises 10 to 30 bricks along the width direction of the crown, and the weight of each brick is 5 to 15 kg. Preferably, the crown brick layer comprises 15 to 25 bricks along the width direction of the crown, and more preferably, the crown brick layer comprises 21 bricks along the width direction of the crown. The weight of each brick is preferably 6 to 11 kg, and more preferably 8 kg.

Wherein, the material of the crown brick is synthetic mullite.

Wherein, the connection surface of the supporting column and the crown is a slanting surface.

Wherein, the supporting column is a skew brick structure.

Wherein, the glass fiber tank kiln passage crown structure further comprises a set screw, which is tightly fastened to the side of the supporting column.

The beneficial effects of the present disclosure include:

The crown structure at the top of the glass fiber tank kiln passage provided by the present disclosure is of an arch structure. With this structure, the width of the passage to be constructed is increased, and easy construction and solid structure of the passage are achieved; besides, the softening and sinking of the roof part of the passage can be effectively prevented and the safety risks can thus be reduced.

### BRIEF DESCRIPTION OF THE DRAWINGS

The drawings incorporated in the description and constituting a part of the description show the embodiments of the present disclosure, and are used for explaining the principle of the present disclosure in combination with the description. In these drawings, similar reference numerals represent similar elements. The drawings described hereinafter are some of but not all of the embodiments of the present disclosure. A person of ordinary skill in the art can obtain other drawings according to these drawings without paying any creative effort.

FIG. 1 is a schematic view of the top structure of the glass fiber tank kiln passage according to the existing technology; and

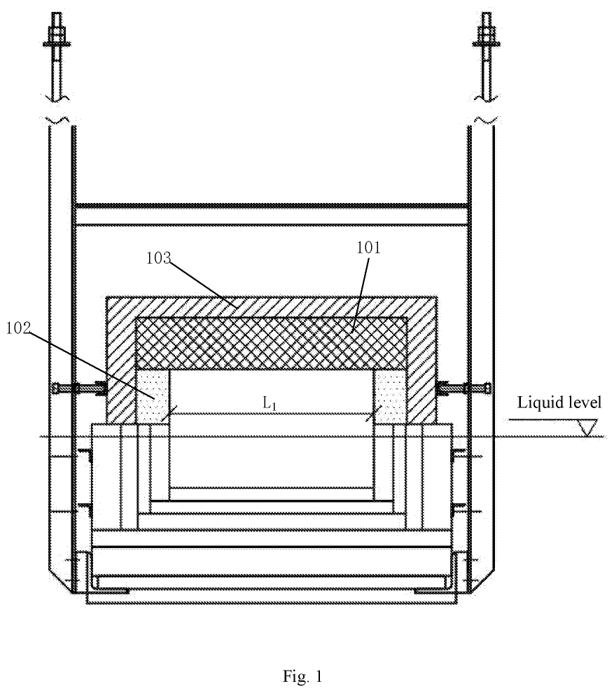

FIG. 2 is a schematic view of the crown structure at the top of the glass fiber tank kiln passage according to the present disclosure.

### DETAILED DESCRIPTION OF THE EMBODIMENTS

To make the objectives, technical solutions and advantages of the embodiments of the present disclosure clearer, the technical solutions in the embodiments of the present disclosure will be described clearly and completely with reference to the accompanying drawings in the embodiments of the present disclosure. Apparently, the described embodiments are just some of but not all of the embodiments of the present disclosure. All other embodiments obtained by a person of ordinary skill in the art based on the embodiments of the present disclosure without paying any creative effort shall fall into the protection scope of the present disclosure. It is to be noted that the embodiments in the present disclosure and the features in the embodiments can be combined at will if not conflicted.

The crown structure designed by the inventors is in the form of an arch to be used in a glass fiber tank kiln passage. The design not only meets the requirement of widening the passage under the technical development and requirement, but also has the advantages of simple structure and convenient construction. Further, it can effectively prevent the softening and sinking of the roof part of the passage, thus enhancing safety factor of production by reducing safety risks. In addition, the design can also effectively prevent the refractory scraps caused by the softening and sinking of the passage roof from falling into the molten glass below so as to avoid the negative impact on the glass quality.

The glass fiber tank kiln passage crown structure according to the present disclosure will be described below in detail with reference to the accompanying drawings.

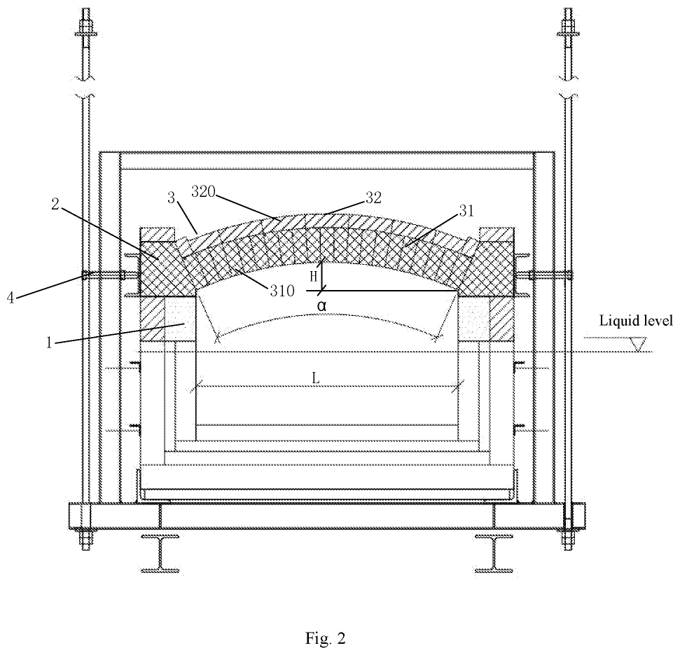

FIG. 2 shows a schematic view of the glass fiber tank kiln passage crown structure in one embodiment of the present disclosure. As shown in FIG. 2, the crown structure comprises a chest wall brick 1, a supporting column 2 and a crown 3, wherein the crown 3 is of an arch structure, the supporting column 2 is built on the top of the chest wall brick 1, and the two ends of the crown 3 are built on the supporting column 2. The chest wall brick 1, being the base of the crown structure, is built on the top of the side wall of the kiln, and the bottom of the chest wall brick 1 is higher than the glass level in the kiln. The supporting column 2 is built on the top of the chest wall brick 1 and directly connected to the two ends of the crown 3 so as to fasten the crown 3.

It is to be noted that, with respect to the glass fiber tank kiln passage crown structure of the present disclosure, the span L of the crown 3 can either be greater than 1 meter, or less than or equal to 1 meter. That means the passage crown structure according to the present disclosure can be used both in a conventional glass fiber tank kiln passage and in a large-sized glass fiber tank kiln passage. In general, the span L of the crown 3 is 0.5 to 4.0 meters, preferably 0.8 to 3.0 meters, more preferably 1.0 to 2.0 meters, and even more preferably 1.0 to 1.5 meters. Correspondingly, the central angle α of the crown 3 is 20° to 70°, and the ratio of the height H to the span L of the crown 3 is 0.044 to 0.158.

In a specific embodiment of this disclosure, the span L of the crown 3 is 0.8 to 3.0 meters, the central angle α of the crown 3 is 30° to 60°, and the ratio of the height H to the span L of the crown 3 is 0.066 to 0.134. The crown of that dimension can meet most of the production requirements, so that the roof part of the passage will not soften and sink under high temperature during production, and the safety risks will thus be avoided.

Preferably, the span L of the crown 3 can be 1.0 to 1.5 meters, the central angle α of the crown 3 can be 40° to 50°, and the ratio of the height H to the span L of the crown 3 can be 0.088 to 0.111.

In an exemplary embodiment of this disclosure, the central angle α of the crown 3 can be 30°, 35°, 42°, 48°, 50°, 56° or 60°. When the width of the passage is relatively small, for example, when the span L of the crown 3 is less than or equal to 1 meter, or even less than 0.8 meter, the central angle α of the crown 3 can be less than 30°; the central angle α of the crown 3 can be 20° or 28°, for example. Table 1 below shows a comparison of the sinking distance within 4 years of operation between the passage roof of the existing technology and the passage crown according to the present disclosure. As shown in Table 1, a greater span will result in longer sinking distance during the operation of the passage, while for the same span, the sinking distance of the crown according to the present disclosure is almost negligible as compared with that of the roof in the existing technology.

TABLE 1
Comparison of Sinking Distance of Different Passage
Roof Structures after A Period of Operation

| | | Sinking distance (mm) | | | |
|---|---|---|---|---|---|
| Passage roof | | After 1 | After 2 | After 3 | After 4 |
| structure | Span L (m) | year | years | years | years |
| Passage roof in | 0.6 | 8 | 18 | 29 | 40 |
| the existing | 1 | 20 | 45 | 75 | 110 |
| technology | | | | | |
| Passage crown | 1 | 0 | 2 | 5 | 8 |
| according to the | 3 | 2 | 4 | 7 | 11 |
| present disclosure | | | | | |

Table 2 shows some reference values for parameters of the crown structure according to the present disclosure.

TABLE 2
Parameter Values of the Crown Structure

| | Central angle α | Ratio of the height H to |
|---|---|---|
| Crown span L (m) | (degree) | the span L of the crown |
| 0.5~4 | 20 | 0.044 |
| | 30 | 0.066 |
| | 40 | 0.088 |
| | 50 | 0.111 |
| | 60 | 0.134 |
| | 70 | 0.158 |

In an exemplary embodiment of this disclosure, the crown 3 includes a crown brick layer 31 and an insulation layer 32, with the insulation layer 32 covering and being built on the upper surface of the crown brick layer 31. Wherein, the crown brick layer 31 is suspended at the top of the passage, receiving heat radiation from the molten liquid in the passage, and the two ends of the crown brick layer 31 are built on the supporting column 2. The insulation layer 32 covers the upper surface of the crown brick layer 31 so as to form sealed insulation for the passage and reduce heat loss.

Specifically, the crown brick layer 31 comprises a plurality of crown bricks 310 built side by side. The crown brick 310 is in the shape of an arch, so that the crown brick layer 31 formed with the successively built crown bricks 310 is of an arch structure, and thus the crown 3 will be an arch structure. With this design, the sinking of the middle part of the crown brick layer due to the effect of thermal softening can be effectively avoided. The insulation layer 32 comprises a plurality of insulation bricks 320 which are laid in sequence in a direction perpendicular to that of the crown bricks 310. A plurality of crown bricks 310 are erected on their sides and built adjacently and in sequence to form the crown brick layer 31, while the insulation bricks 320 are paved on the surface of the crown brick layer 31, or specifically, the insulation brick 320 covers the masonry joint between two adjacent crown bricks 310, so as to effectively reduce the heat loss through the crown brick layer 31, ensure the controllability of production process parameters, and maintain smooth production.

Generally, the crown brick layer 31 comprises 10 to 30 crown bricks 310 along the width direction of the crown, the weight of the crown brick 310 each being 5 to 15 kg. Preferably 15 to 25 crown bricks, or more preferably 21 crown bricks, are built along the width direction of the crown. The weight of each crown brick is preferably 6 to 11 kg, and more preferably 8 kg. In an exemplary embodiment, the width of the passage is 1.5 meters, that is, the span L of the crown 3 is 1.5 meters; in that case, the central angle of the crown 3 can be 50°, and the crown brick layer can comprise 15 crown bricks 310 with each having a weight of 6 kg.

It is to be noted that the material of the crown brick can be synthetic mullite. This material has low density, which means relatively light weight for a given volume, low material consumption, and low price. In addition, the crown brick can also be re-sintered fusion mullite brick, silica brick or fused zirconia corundum brick.

In order to facilitate the construction work and the batch processing of the raw materials, the crown bricks 310 used for the crown 3 have a uniform shape and dimension. Therefore, the two ends of the arch-shaped crown brick layer 31 built by masonry are slanting surfaces. In order to ensure the stability of the crown structure and facilitate the construction of the crown brick layer 31, the connection surface between the supporting column 2 and the crown 3 is a slanting surface, that is, one side of the supporting column 2 is an inclined structure, with the inclination angle equaling half of the central angle α of the crown 3.

Specifically, the supporting column 2 is a skew brick structure. In the embodiment as shown in FIG. 2, the supporting column 2 is a wedge-shaped skew brick structure.

In addition, the glass fiber tank kiln passage crown structure according to the present disclosure further comprises a set screw 4, which is tightly fastened to the side of the supporting column 2. In the embodiment shown in FIG. 2, the set screw 4 passes through the side wall or column of the glass fiber tank kiln frame, and presses against the side of the supporting column 2. With the set screws 4 on both sides of the tank kiln passage, the supporting columns 2 at the two ends of the crown 3 are pressed towards the middle of the passage, which further strengthens the structural stability of the crown, and prevents the crown brick layer 31 from sinking due to high temperature softening, thus reducing safety risks of the crown structure during production; besides, the use of set screws can also help to prevent refractory scraps, which are caused by the softening and sinking of the crown brick layer, from falling into the molten glass below so as to avoid the negative impact on the glass quality.

Finally, it is to be noted that, in the glass fiber tank kiln passage crown structure according to the present disclosure, insulation bricks are applied on the outer surface of the chest wall brick 1 and on the top of the supporting column 2 to further reduce heat loss during production.

The contents described above can be implemented independently or in combination in various ways, and these transformations shall fall into the protection scope of the present disclosure.

The specific dimension values of the components listed herein are exemplary numerical values, and dimension parameters of different components can have different numerical values as required in practical operations.

It is to be noted that, as used herein, the term “comprise/comprising,” “contain/containing” or any other variants thereof is non-exclusive, so that an object or a device containing a series of elements contains not only these elements, but also other elements not listed clearly, or further contains inherent elements of the object or device. Unless otherwise defined herein, an element defined by the statement “comprises/comprising an/a . . . ” does not exclude other identical elements in the object or device including this element.

The foregoing embodiments are merely used for describing the technical solutions of the present disclosure and not intended to constitute any limitations thereto, and the present disclosure has been described in detail just by preferred embodiments. It should be understood by a person of ordinary skill in the art that modifications or equivalent replacements can be made to the technical features of the present disclosure without departing from the spirit and scope of the technical solutions of the present disclosure, and these modifications or equivalent replacements shall fall into the scope defined by the appended claims of the present disclosure.

### INDUSTRIAL APPLICABILITY

The glass fiber tank kiln passage crown structure provided by the present disclosure is of an arch structure. The crown structure can not only meet the requirement of the widening of the passage under the technical development and requirement, but also enable simple and solid structure as well as easy construction. Further, the crown structure can effectively prevent the sinking of the roof part of the passage, thus enhancing safe production by reducing potential safety risks. In addition, it can also prevent refractory scraps caused by the softening and sinking of the passage roof from falling into the molten glass below, so as to avoid the negative impact on the glass quality.

1.-9. (canceled)

10. A glass fiber tank kiln passage crown structure comprising:
a chest wall brick;
a supporting column built on a top of the chest wall brick; and
a crown having an arch structure, two ends of the crown being built on the supporting column, and a span of the crown being in a range from 0.5 meters to 4 meters.

11. The glass fiber tank kiln passage crown structure according to claim 10, wherein a central angle of the crown is in a range from 20° to 70°.

12. The glass fiber tank kiln passage crown structure according to claim 10, wherein a ratio of a height of the crown to the span of the crown is in a range from 0.044 to 0.158.

13. The glass fiber tank kiln passage crown structure according to claim 10, wherein the crown includes:
a crown brick layer; and
an insulation layer covering and built on an upper surface of the crown brick layer.

14. The glass fiber tank kiln passage crown structure according to claim 13, wherein:
the crown brick layer includes a plurality of crown bricks built side by side and each having an arch shape;
the insulation layer includes a plurality of insulation bricks laid in sequence; and
a laying direction of the insulation bricks is perpendicular to a building direction of the crown bricks.

15. The glass fiber tank kiln passage crown structure according to claim 14, wherein the crown brick layer includes 10 to 30 crown bricks along a width direction of the crown, and a weight of each crown brick is in a range from 5 kg to 15 kg.

16. The glass fiber tank kiln passage crown structure according to claim 10, wherein a connection surface between the supporting column and the crown is a slanting surface.

17. The glass fiber tank kiln passage crown structure according to claim 10, wherein the supporting column is a skew brick structure.

18. The glass fiber tank kiln passage crown structure according to claim 10, further comprising:
a set screw tightly fastened to a side of the supporting column.
